(19) United States
(12) Patent Application Publication
(10) Pub. No.: US 2002/0085462 A1
(43) Pub. Date: Jul. 4, 2002

(54) Method and optical recording apparatus for determining the optimum write power

(76) Inventor: Johannes Hendrikus Maria Spruit, Eindhoven (NL)

Correspondence Address: Michael E. Marion, Philips Electronics North America Corp., 580 White Plains Road, Tarrytown, NY, 10591, US

(21) Appl. No.: 10/011,884

(22) Filed: Dec. 4, 2001

(30) Foreign Application Priority Data
Dec. 4, 2000 (EP) 00204315.6

(51) Int. Cl. G11B 7/125

(52) U.S. Cl. 369/47.53

(57) ABSTRACT

A method and an optical recording apparatus for determining the optimum write power in an OPC-procedure are described. The method involves erasing a test area, recording test patterns in the test area, reading the recorded test patterns and determining the optimum write power from signal portions of the read signal. Erasing the test area, even when no signals are recorded therein, produces a reliable and unambiguous value of the optimum write power.

The invention relates to a method for setting an optimum value (Pₒₚₜ) of a write power level (P) of a radiation beam for use in an optical recording apparatus for writing information on an optical recording medium, the optical recording medium comprising an information layer having a phase reversibly changeable between a first state and a second state, the information being written on the optical recording medium in the form of marks by applying the radiation beam to an area of the information layer so as to cause the area of the information layer to become the first state, thereby forming the mark, the method comprising a first step of writing a series of test patterns, each test pattern comprising marks, in a test area on the recording medium, each test pattern being written with a different value of the write power level (P) of the radiation beam, a second step of reading the written test patterns so as to form corresponding read signal portions, and a third step of selecting the optimum value (Pₒₚₜ) of the write power level (P) in dependence on the read signal portions.

The invention also relates to an optical recording apparatus for recording information on an optical recording medium, comprising a radiation source for emitting a radiation beam for recording information on the recording medium, the radiation beam having a controllable value of a write power level (P), a control unit operative to record a series of test patterns in a test area on the recording medium, each pattern being recorded with a different value of the write power level (P), a read unit for reading the recorded test patterns and for forming corresponding read signal portions, and setting means for setting an optimum value (Pₒₚₜ) of the write power level in dependence on the read signal portions.

A method and apparatus according to the first paragraph are known from the European patent application No. EP 0 737 962. The apparatus uses a method for setting the optimum write power (Pₒₚₜ) of the radiation beam which includes the following steps. First the apparatus records a series of test patterns on the recording medium, each test pattern with increasing write power (P). Next, it derives the modulation (M) of each recorded test pattern from the read signal portions corresponding to each of the test patterns. It calculates the derivative of the modulation (M) as a function of the write power (P) and normalizes the derivative by multiplying it by the write power (P) over the modulation (M). The intersection of the normalized derivative (γ) with a preset value (γ_{target}) determines a target write power level (P_{target}). Finally, the target write power (P_{target}) is multiplied by a parameter (p) so as to obtain an optimum value (Pₒₚₜ) of the write power level (P) best suited for recording on the recording medium. The value of the parameter (p) is read from the recording medium itself. The test patterns are recorded on the recording medium by applying write power (P) values in a range around a given value (P_{ind}) which is also read from the recording medium itself

The test patterns are recorded in a test area on the recording medium. In general this test area is an area specially reserved for recording test patterns. Such a reserved area is, for example, know as a Drive Test Zone or as a Disc Test Zone. The test area may consist of one continuous area or alternatively may be composed of several sub-areas.

It is to be noted that the not prepublished European patent application PHNL000685 describes an alternative method and an apparatus using the alternative method. In this alternative method, the optimum value (Pₒₚₜ) of the write power level (P) is determined directly from the relation between the modulation times the write power level (i.e., M·P) and the write power level (P).

In an optical recording apparatus it is important to record information on optical recording media with the correct power of the radiation beam. A media manufacturer cannot give this correct power in an absolute way (for example, pre-recorded on the disc) because of environment and apparatus-to-apparatus deviations for every recording medium and recording apparatus combination. The known methods for setting the optimal write power (Pₒₚₜ) take the different characteristics of the recording media into account. Furthermore, the methods are independent of the specific recording apparatus. They are designed for providing a proper setting of the write power of the radiation beam for each combination of recording apparatus and recording medium. Such methods are often referred to as OPC (Optimum Power Calibration) procedures.

However, it is a disadvantage of the know method that an unambiguous value for the optimal write power level (Pₒₚₜ) is not always obtained. This is especially the case for recording media comprising an information layer having a phase reversibly changeable between a first state and a second state such as, for example, an information layer of the phase change type having a crystalline and an amorphous state. On such a phase change type information layer a mark is formed, for example, by an amorphous area within a crystalline surrounding. Recording media comprising a phase change type information layer include, for example, CD-RW and DVD-RW discs.

It is to be noted that within the scope of this application marks are considered to include all detectable areas on a recording medium such as, for example, amorphous areas within a crystalline surrounding on a recording medium of the phase change type discussed above. However, marks are not limited to optically detectable regions but magnetically or magneto-optically detectable regions may alternatively be used.

It is an object of the present invention to provide a method according to the opening paragraph which determines an unambiguous optimum value of the write power level.

This object is achieved when the method set forth in the preamble is characterized in that the method also includes, before the first step, an initialization step of applying the radiation beam having an erase power level to the test area so as to cause the information layer in the test area to become the second state. When the test area is erased by irradiating the test area with a radiation beam having an erase power level before the test patterns are recorded, reading the recorded patterns will yield read signal portions wherefrom an unambiguous optimum value (Pₒₚₜ) of the write power level (P) can be deduced.

It is to be noted that the initialization step of erasing the test area should always be executed, irrespective of whether or not any information is recorded in the test area. The initialization step of erasing the test area should be executed even when a new recording medium, i.e. a medium that is, has never been used before to record user information, is used. Experiments performed by the inventor have a much more accurate and unambiguous value (Pₒₚₜ) of the write power level (P) could be deduced revealed especially for new recording mediums.

It is also to be noted that erasing the test area by writing the test patterns while using a Direct-Overwrite (DOW) technique, that is, writing information to be recorded in the information layer and at the same time erasing information previously written in the information layer, is inadequate. The test area should preferably be erased by a so called DC erasure, that is, applying a radiation beam having a constant erase power level without write pulses in between, before writing the test patterns. After erasure, the test patterns may be recorded using a DOW or any other recording technique.

An embodiment of the method according to the invention is characterized in that the third step includes a first intermediate step of deriving a value of a read parameter from each read signal portion, the values representing a relation between the read parameter and the write power level (P), and a second intermediate step of selecting the optimum value (Pₒₚₜ) of the write power level (P) in dependence on the relation between the read parameter and the write power level (P).

It is also an object of the present invention to provide an apparatus according to the opening paragraph operative to use a method according to the invention.

This object is achieved when the optical recording apparatus set forth in the preamble is characterized in that the radiation source is also equipped to emit a radiation beam for erasing information from the recording medium, the radiation beam having a controllable value of an erase power level, and in that the control unit is also operative to control the radiation source such that it applies the radiation beam having the erase power level to the test area on the recording medium before the series of test patterns are recorded on the recording medium. Such a recording apparatus is operative to erase the test area before the test patterns are recorded. The test area is erased by irradiating it with a radiation beam having an erase power level. Preferably, the radiation beam should have a constant erase power level without write pulses in between.

The objects, features and advantages of the invention will be apparent from the following more specific descriptions of examples of embodiments of the invention, as illustrated in the accompanying drawings where

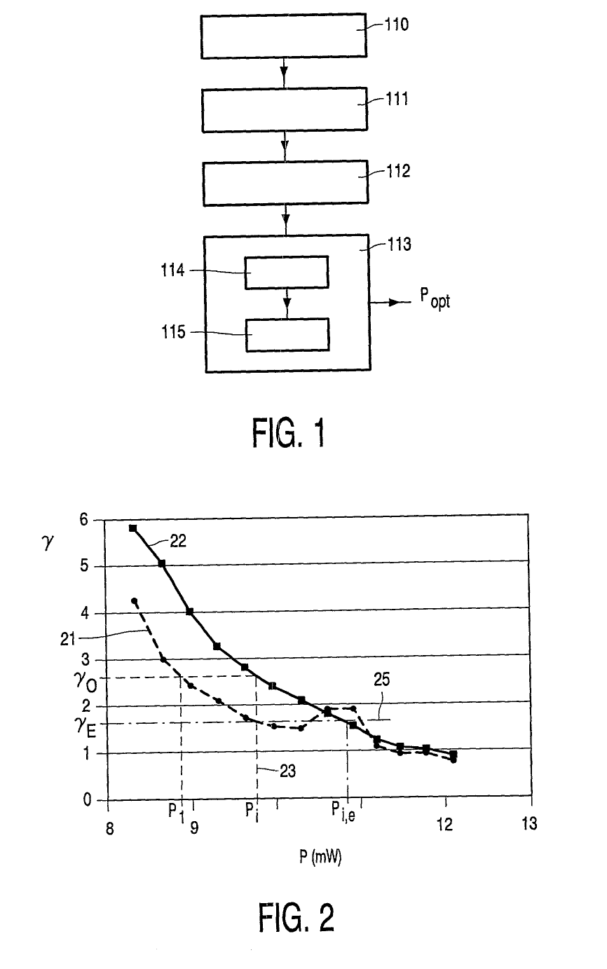

FIG. 1 is a flow chart of a version of the method according to the invention,

FIG. 2 is a graph showing the derivative of the measured modulation as a function of the write power level,

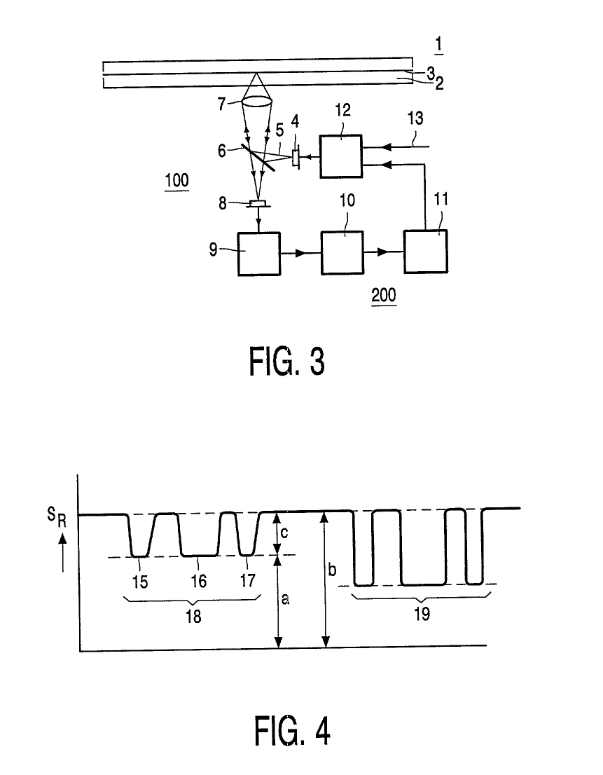

FIG. 3 shows an embodiment of the optical recording apparatus according to the invention, and

FIG. 4 illustrates two read signal portions from two test patterns.

FIG. 3 shows an optical recording apparatus and an optical recording medium 1 according to the invention. The recording medium 1 has a transparent substrate 2 and an information layer 3 arranged on it. The information layer 3 comprises a material suitable for recording information by means of a radiation beam 5. The recording material may be of, for example, the phase-change type, the magneto-optical type, or any other suitable material. Information may be recorded in the form of optically detectable marks on the information layer 3. The apparatus comprises a radiation source 4, for example a semiconductor laser, for emitting a radiation beam 5. The radiation beam is converged on the information layer 3 via a beam splitter 6, an objective lens 7 and the substrate 2. Radiation reflected from the medium 1 is converged by the objective lens 7 and, after passing through the beam splitter 6, it is incident on a detection system 8 which converts the incident radiation into electric detector signals. The detector signals are applied to a circuit 9. The circuit 9 derives several signals from the detector signals, such as a read signal S_{R} representing the information being read from the recording medium 1. The radiation source 4, the beam splitter 6, the objective lens 7, the detection system 8 and the circuit 9 together form a read unit 100.

The read signal S_{R} from the circuit 9 is processed in a first processor 10 in order to derive signals representing a read parameter from the read signal S_{R}. The derived signals are fed to a second processor 11 which processes a series of values of the read parameter and sets, on the basis thereof, an optimum a write power control signal necessary for controlling the laser power level (P). The first processor 10 and the second processor II together form the setting means 200. A processor is understood to mean any means suitable for performing calculations, for example, a micro-processor, a digital signal processor, a hard-wired analog circuit or a field programmable circuit. Furthermore, the first processor 10 and the second processor 11 may be separate devices or, alternatively, may be combined into a single device executing both processes.

The write power control signal is applied to a control unit 12. An information signal 13, representing the information to be recorded on the recording medium 1, is also fed to the control unit 12. The output of the control unit 12 is connected to the radiation source 4. A mark on the recording layer 3 may be recorded by a single radiation pulse, the power of which is determined by the write power control signal as determined by the setting means 200. Alternatively, a mark may also be recorded by a series of radiation pulses of equal or different length and one or more power levels, each level being determined by the write power control signal as determined by the setting means 200.

Before recording information on the recording medium 1 the apparatus sets its write power (P) to the optimum value (Pₒₚₜ) by performing a method according to the invention. This method is schematically depicted in the flow chart shown in FIG. 1.

First, in an initialization step 110, the apparatus applies a radiation beam 5 having an erase power level to the test area on the recording medium 1. The control unit 12 controls the radiation source 4 such that it emits a radiation beam 5 having a constant erase power level. When a so-called “black-writing” record carrier of the phase change type is used, the information layer 3 in the test area becomes the crystalline state. Previously written marks, represented by amorphous areas, are erased. When a new recording medium, that is, a medium which has never been used before to record user information, is used, the information layer 3 in the test area becomes a stable and reproducible crystalline state.

Next, in the first step 11 1, the apparatus writes a series of test patterns in the test area on the recording medium 1. The test patterns should be selected so as to give a desired read signal. If the read parameter to be derived from the read signal is the modulation (M) of a read signal portion pertaining to a test pattern, the test pattern should comprise marks sufficiently long to achieve maximum modulation of the read signal portion. When the information is coded according to the so-called Eight-to-Fourteen Modulation (EFM), the test patterns preferably comprise the long I11 marks of the modulation scheme. When the information is coded according to the Eight-to-Fourteen Plus Modulation (EFM+), the test patterns preferably comprise the long I14 marks of this modulation scheme. Each test pattern is recorded with a different write power level (P). The range of the powers may be selected on the basis of an indicative power level (P_{ind}) recorded as control information on the recording medium. Subsequent test patterns may be recorded with a step-wise increased write power level (P) under the control of the control unit 12.

In the second step 112 the recorded test patterns are read by the read unit 90 so as to form a read signal SR. FIG. 4 shows the read signal SR and two read signal portions 18 and 19 obtained from two test patterns written at two different write power levels. The test patterns shown comprise a short mark, a long mark and a short mark, as denoted by the signal parts 15, 16 and 17, respectively, in both the read signal portion 18 and the read signal portion 19. An actual test pattern may comprise a few hundred marks of different or equal length.

In the first intermediate step 114 of the third step 113 of the method, thr processor 10 derives from the read signal SR a read parameter for each read signal portion 18,19. A possible read parameter is the ratio of the lowest level of the amplitude of a read signal portion (for the read signal portion 18 indicated by ‘a’ in FIG. 4) to the maximum level of the amplitude of the same read signal portion (indicated by ‘b’). A preferred read parameter is the modulation (M), being the ratio of the maximum peak-to-peak value of a read signal, indicated by ‘c’, to the maximum amplitude ‘b’ of the read signal portion.

Next, series of value pairs for the modulation (M) of a pattern and the write power (P) with which that pattern has been written are formed. The write powers may be taken from the value of the write power control signal during the recording of the test patterns or, alternatively, from a measurement of the radiation power. A curve is fitted through the measured modulation values in order to obtain an analytic expression for the variation of the modulation as a function of the write power. This fitting may be done, for example, by means of the well-known least-squares fitting algorithm.

In the second intermediate step 1 15 of the third step 1 13 the processor 111 calculates a normalized derivative γ of the measured modulation as a function of the write power level (P). This normalized derivative γ(P) is equal to the function (dM/dP).P/M. FIG. 2 shows two graphs representing the normalized derivative γ of the measured modulation as a function of the write power level P. The dashed curve 21 represents the normalized derivative γ derived by using the method known from the prior art while the solid curve 22 represents the normalized derivative γ derived by using the method according to the present invention. Both graphs were obtained from measurements using identical recording media.

Next, the processor 11 derives an intermediate write power level Pᵢ from the normalized derivative γ. The intermediate write power level Pᵢ is derived by reading a preset value γ₀ from the recording medium and determining the value of the write power level P belonging to the preset value γ₀ as indicated by the dashed line 23 in FIG. 2. Finally, the optimum value (Pₒₚₜ) of the write power level (P) is obtained by multiplying the intermediate power level Pᵢ by a predetermined constant p larger than one, i.e. Pₒₚₜ=ρ·Pᵢ. The preset value γ₀ and the predetermined constant ρ may have values set by the manufacturer of the recording medium and pre-recorded on the recording medium itself in an area on the recording medium comprising control information indicative of a recording process whereby information can be recorded on said recording medium.

As stated before FIG. 2 shows two graphs representing the normalized derivative γ of the measured modulation as a function of the write power level P. The dashed curve 21 represents the normalized derivative γ derived by using the method known from the prior art while the solid curve 22 represents the normalized derivative γ derived by using the method according to the present invention. Both graphs were obtained from measurements using identical new recording media, i.e. media which were never used before to record user information. From FIG. 2 it is evident that the intermediate write power level Pᵢ obtained by using the method according to the present invention deviates significantly from the intermediate write power level P₁ obtained by using the method known from the prior art. Experiments have revealed the normalized derivative γ derived by using the method according to the present invention (solid curve 22) was reproducible, i.e. successive OPC-procedures resulted in a substantially identical curve, whereas the normalized derivative γ derived by using the method known from the prior art (dashed curve 21) was not. It appeared that in a second OPC-procedure using the method known from the prior art the dashed curve 21 was shifted towards the solid curve 22.

Furthermore, when a preset value YE is used no unambiguous value for the intermediate power level, and therefore for the optimum value (Pₒₚₜ) of the write power level, can be derived from the normalized derivative Y derived by using the method known from the prior art (dashed curve 21). This is because the dash-dotted line 25, corresponding to the preset value YE, crosses the dashed curve 21 for three different values of the write power level (P). However, the normalized derivative y derived by using the method according to the present invention (solid curve 22) was found to be represented by a monotonously decreasing function. Therefore, an unambiguous value for the intermediate power level, and therefore for the optimum value (Pₒₚₜ) of the write power level, can always be derived because such a monotonously decreasing function has only a single value P_{i,E} of the write power level (P) for which it crosses a horizontal line 25.

It should be noted that the above-mentioned versions and embodiments illustrate rather than limit the invention, and that those skilled in the art will be able to design alternatives without departing from the scope of the appended claims. Furthermore, the word “comprise” and its conjugations do not exclude the presence of steps or elements other than those listed in the claims. Any reference sign placed between parentheses in the claims shall not be construed as limiting the claims.

1. A method for setting an optimum value (Pₒₚₜ) of a write power level (P) of a radiation beam (5) for use in an optical recording apparatus for writing information on an optical recording medium (1), the optical recording medium comprising an information layer (3) having a phase reversibly changeable between a first state and a second state, the information being written on the optical recording medium in the form of marks by applying the radiation beam to an area of the information layer so as to cause the area of the information layer to become the first state, thereby forming the mark,
the method comprising a first step of writing a series of test patterns, each test pattern comprising marks, in a test area on the recording medium, each test pattern being written with a different value of the write power level (P) of the radiation beam,
a second step of reading the written test patterns to form corresponding read signal portions,
and a third step of selecting the optimum value (Popt) of the write power level (P) in dependence on the read signal portions,
characterized in that the method also includes before the first step, an initialization step of applying the radiation beam having an erase power level to the test area so as to cause the information layer in the test area to become the second state.

2. A method as claimed in claim 1, characterized in that the third step includes a first intermediate step of deriving a value of a read parameter from each read signal portion, the values representing a relation between the read parameter and the write power level (P), and a second intermediate step of selecting the optimum value (Pₒₚₜ) of the write power level (P) in dependence on the relation between the read parameter and the write power level (P).

3. An optical recording apparatus for recording information on an optical recording medium (1), comprising a radiation source (4) for emitting a radiation beam (5) for recording information on the recording medium, the radiation beam having a controllable value of a write power level (P),
a control unit (12) operative to record a series of test patterns in a test area on the recording medium, each pattern being recorded with a different value of the write power level (P),
a read unit (100) for reading the recorded test patterns and for forming corresponding read signal portions, and
setting means (200) for setting an optimum value (Pₒₚₜ) of the write power level in dependence on the read signal portions,
characterized in that the radiation source (4) is also equipped to emit a radiation beam (5) for erasing information from the recording medium (1), the radiation beam (5) having a controllable value of an erase power level,
and in that the control unit (12) is also operative to control the radiation source (4) such that it applies the radiation beam (5) having the erase power level to the test area on the recording medium (1) before the series of test patterns are recorded on the recording medium.

4. An optical recording apparatus as claimed in claim 3, characterized in that the control unit (12) is operative to control the radiation source (4) such that is applies a radiation beam (5) having an erase power level of constant value to the test area on the recording medium (1) before the series of test patterns are recorded.
